(19) United States
(12) Patent Application Publication
(10) Pub. No.: US 2006/0279675 A1
(43) Pub. Date: Dec. 14, 2006

(54) EXTRACORPOREAL SHOCK WAVE TREATMENT DEVICE WITH IMPROVED ALIGNMENT MEANS

(76) Inventor: Christopher A. Nowacki, Long Grove, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/308,647

(22) Filed: Apr. 17, 2006

Related U.S. Application Data
(60) Provisional application No. 60/594,535, filed on Apr. 15, 2005.

(51) Int. Cl. G02F 1/1335

(52) U.S. Cl. 349/113

(57) ABSTRACT

An extracorporeal shockwave treatment device with improved means for alignment is disclosed. The device includes a reflector having a shock producing electrode. A central viewing device such as an optical fiber connected to a CCD camera is positioned through the electrode along the major axis of the reflector. Thus, the target area on the patient's skin can be viewed and aligned. Alternatively, the viewing device can be on the side of the reflector off-axis, and a laser beam is disposed along the major axis to produce a visible indicator on the patient's skin which can be aligned with the target area. In an alternate embodiment, a plurality of laser beams are positioned on the sides of the reflector, and the viewing device is positioned on the side of the reflector such that the indicators from the laser beams can be arranged to be centered at the center point of the target area. Optionally, the laser beams can converge in a manner which enables the user to determine the depth of the focal point.

### CROSS-REFERENCE TO RELATED APPLICATIONS

This application claims the benefit of U.S. Provisional Application No. 60/594,535, filed Apr. 15, 2005, which is hereby incorporated by reference herein in its entirety.

### TECHNICAL FIELD

The present invention relates to extracorporeal shockwave treatment systems, and more specifically to systems and methods for increasing accuracy in the targeting of a desired treatment location.

### BACKGROUND OF THE INVENTION

Therapeutic devices for extracorporeal disintegration of kidney stones and other bodily concretions are known and used in non-invasive treatment of patients. Some such conventional devices, called lithotripters, have an ellipsoid reflector having two focus points. A spark gap is provided at a first focal point which generates a series of shockwaves or pulses. In some applications, these shockwaves are focused by the walls of the reflector, pass through water or fluid within the reflector, through a diaphragm which is pressed against the body of a patient, and reflected to a second focal point which is coincident with the kidney stone or other concretion. The series of shockwaves disintegrate the kidney stone or concretion into small fragments which can be passed out of the body via urine.

To bring the concretion to the second focal point requires a medical professional with considerable skill and experience with the lithotripter. Typically, a marking of some sort, such as a circle or square, is drawn onto the patient's skin nearest or most convenient to the concretion. During the lithotriptsy procedure, the doctor maneuvers the marked skin to a desired position relative to the lithotripter diaphragm. Once the marked skin is in contact with the diaphragm, the doctor cannot see the marking. This process relies on the doctor's skill and experience at determining how deep into the body the concretion is from the surface of the skin and how the body part is aligned relative to the second focal point of the lithotripter.

Some attempts have been made to improve the positioning of the lithotripter relative to the concretion. For example, U.S. Pat. No. 5,025,789, issued to Hassler, discloses a shock wave source having a central ultrasound locating system. In this system the lithotripsy device has an ultrasound locating system centrally located within the shock wave source.

U.S. Pat. No. 4,821,730, issued to Wurster et al., discloses an ultrasonic scanner and shock wave generator. This device uses one or more ultrasound transducers off axis from an ultrasound shock wave generator. The ultrasound shock wave generator may be used in a low power setting to image the concretion and then used on high power to generate the shock waves. The off axis transducers can be used to generate multiple section images so that it is possible to increase the spatial resolution during location.

U.S. Pat. No. 5,158,085, issued to Belikan et al., discloses a lithotripsy ultrasound locating device. The device has at least on locating ultrasound transducer having multiple focal ranges for locating the concretion. Computer control is used to determine the distance between the head of the locating transducer and the focus of a therapy (shock wave generating) transducer.

However, there remains a need for a system that permits the treating physician to see target area and align the target area with the second focus of the lithotripter. Therefore, it would be desirable to produce a system that allows a treating physician to see and manipulate the marked target area relative to the lithotripter and thus improve the treatment of body concretions.

### SUMMARY

In view of the deficiencies described above, it is an object of the present invention to provide an improved extracorporeal shockwave treatment device for extracorporeal shockwave treatment, and a related method for manufacturing such a device and for treating a patient via use of such a reflector.

In accordance with the above objectives, the present invention is an improved device for extracorporeal shockwave treatment.

Other features and advantages of the invention will be apparent from the following detailed description taken in conjunction with the following drawings.

### BRIEF DESCRIPTION OF THE FIGURES

FIG. 1 shows a typical lithotripsy device.

FIG. 2 shows perspective view of an ellipsoid treatment apparatus of a lithotripsy device having camera and a light source in accordance with the present invention.

FIG. 3 shows a cross sectional view of an ellipsoid treatment apparatus of a lithotripsy device having camera and a light source in accordance with the present invention.

### DETAILED DESCRIPTION

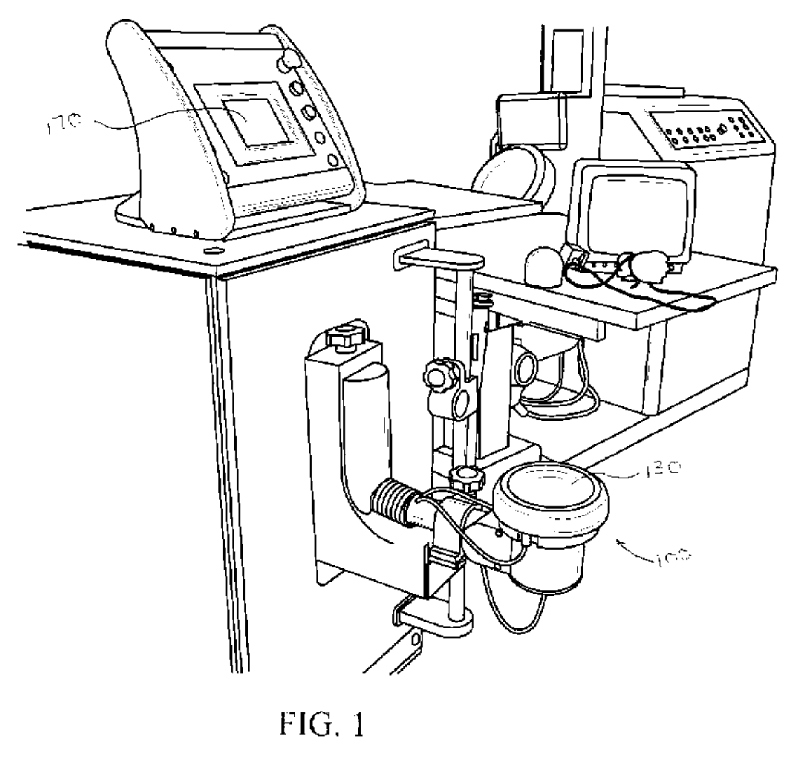

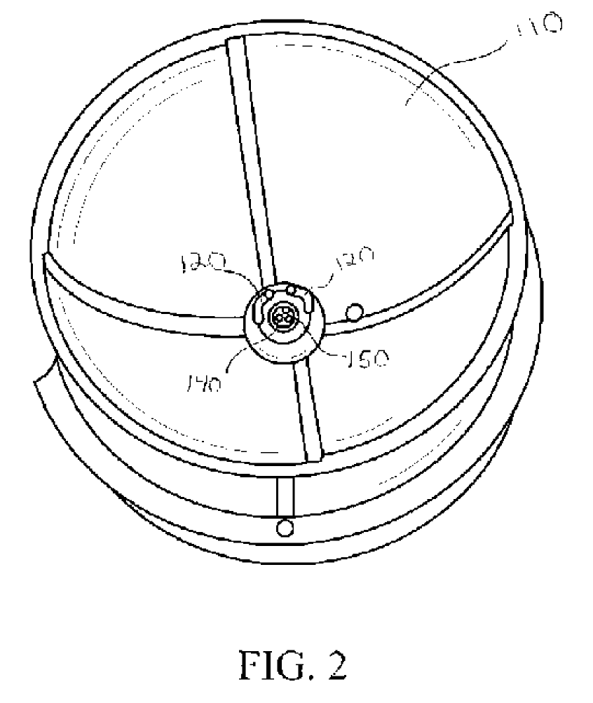

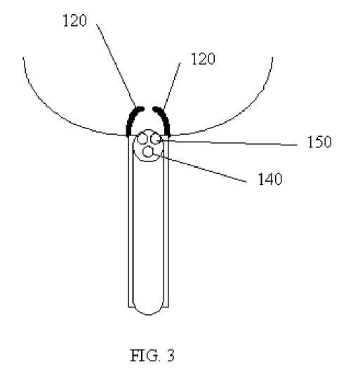

In FIGS. 1-3 the following reference numeral correspond to the following features:
100 Lithotripsy Device;
110 Ellipsoid;
120 Electrodes;
130 Diaphragm;
140 Camera;
150 Light Source;
160 Wiring Passage; and
170 Viewing Screen.

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

While the specific embodiments have been illustrated and described, numerous modifications come to mind without significantly departing from the spirit of the invention, and the scope of protection is only limited by the scope of the accompanying claims.

Typically, when preparing a patient for treatment with an extracorporeal shockwave treatment device, a target such as a square shape is drawn on the patient's skin to indicate where the focus of the treatment should be. The manner in which this target area is aligned with the reflector device is conventionally rather imperfect. Generally, the physician or technician would visually align the square area with the central area of the membrane which covers the reflector, viewing it from the side.

The present invention, in various embodiments, is a reflector which enables the user to view the target area, such as with a camera, such as a CCD camera. In certain embodiments, an image conduit such as an optical fiber is placed internally within the reflector. In one embodiment, the optical fiber is placed through the electrode and aligned so that the view is up along the central axis of the ellipsoid reflector. It is preferably aligned to view through the gap in the electrode nodes. Thus, it will automatically be in line with the target focus point of the reflector. By viewing the image using the camera, the user is able to see the square as it is in contact with the membrane, and align the body portion, such as the foot, so that the center of the square is in line with the image. Targeting indications can be used on a viewing screen for the device.

Ambient light sources can be used to allow for the image to be produced, or alternatively, a light source can be included through the same conduit, or through a separate conduit either through the electrode or through a side portion of the reflector, or elsewhere.

The optical fiber can also be used to transmit information to a computer system which is able to determine whether the electrode is installed properly, or whether the electrode is functioning properly. In various embodiments, the system can be set to create an indication or stop operation if the electrode is not installed properly or is not discharging properly. Furthermore, the system may determine that a greater number of discharges is required for the treatment if some of them are inadequate. The detection can be compared to an expected result with respect to frequency of the discharges, and provide a counter. This would be a more accurate way to determine whether a discharge has taken place, since a trigger does not necessarily mean the discharge actually occurred, but the emission of light would indicate that the discharge occurred.

Other embodiments of the invention include the following. The optical fiber or imaging device can alternatively be placed on the side of the reflector at some point which provides an angle which allows an effective view of the target area. An indicator such as a laser beam can be placed along the central axis through the electrode to produce a visual indication of where the central point of alignment is. Thus, the viewing device (optical fiber plus camera, or camera alone, or other viewing device) would enable the user to determine whether the target area is aligned with the dot or indication produced by the laser beam. In other words, the user can see whether the laser beam indication is in the center of the square.

In view of this, the invention also includes within its scope an electrode having a laser beam device through its central axis, and alternatively, a fiber optic through its central axis.

Another alternative embodiment is as follows. A viewing device such as a camera or optical fiber is disposed on the side of the reflector in such a manner that the user can view the target area from the inside of the reflector. A plurality of laser beams are positioned from different locations about the side of the reflector such that the center point of the laser beam indicators locates the central axis of the ellipsoid. Thus, the user can determine whether the target area is in line with the reflector by determining whether the center point of the laser beam indicators is aligned with the center of the square or marker indication on the patient's skin. Either two, three, four, or more laser beam indicators can be used, preferably in an even distribution about the central axis.

In one related embodiment, the beams could converge at a known distance along the “z” axis, such that, for example, the user would know that if the points converged at the membrane or at the patient's skin, the focal point would be positioned exactly a known distance within the patient's body, such as half an inch, and inch, or any desired depth. Variations on this concept include that the indicators from the beams might be a set distance apart at the skin to correspond to a known depth to the focal point. Also, the point at which the laser beams converge could be set to allow for a desired depth to the focal point from the convergence point. The image is viewed via the viewing device, and adjustments can be made accordingly.

The device of the present invention can incorporate a conventional ellipsoid reflector, or alternatively, a dual focal point reflector as disclosed in the applicant's previous patent application Ser. No. 10/423,244, filed on Apr. 25, 2003, which is hereby incorporated by reference herein in its entirety.

While the specific embodiments have been illustrated and described, numerous modifications come to mind without significantly departing from the spirit of the invention, and the scope of protection is only limited by the scope of the accompanying claims.

What is claimed is:

1. An extracorporeal shockwave treatment device comprising:
a reflector having at least a first focal point where an electrode discharges, and at least a second focal point where a shock wave is directed as a result of a spark created when the electrode discharges,
a membrane covering the reflector, and
a centrally aligned viewing device for viewing a target area aligned along the main axis of the reflector through the electrode, wherein an image obtained from said viewing device is viewable by a user to align said target area.

2. An extracorporeal shockwave treatment device comprising:
a reflector having at least a first focal point where an electrode discharges, and at least a second focal point where a shock wave is directed as a result of a spark created when the electrode discharges,
a membrane covering the reflector,
a centrally aligned laser beam aligned along the major axis of the reflector through the electrode, and
a viewing device positioned on the side of said reflector such that a user can view the target area and align it with an indicator from the laser beam.

3. An extracorporeal shockwave treatment device comprising:
a reflector having at least a first focal point where an electrode discharges, and at least a second focal point where a shock wave is directed as a result of a spark created when the electrode discharges,
a membrane covering the reflector,
a plurality of laser beams disposed on a side area of said reflector positioned to create indicators on said target area,
a viewing device positioned on the side of said reflector such that a user can view the target area and align it with the indicators from the laser beams.
